(19) United States
(12) Patent Application Publication
(10) Pub. No.: US 2026/0003510 A1
(43) Pub. Date: Jan. 1, 2026

(54) ZONED RANDOM WRITE OPERATIONS

(71) Applicant: Micron Technology, Inc., Boise, ID (US)

(72) Inventors: Luca Porzio, Casalnuovo (NA) (IT); Zhou Zhou, Shanghai (CN); Xiao Wang, Shanghai (CN); Fangfang Gao, Shanghai (CN); Cun Chen, Shanghai (CN); Mingyi Li, Shanghai (CN); Min Li, Shanghai (CN)

(21) Appl. No.: 19/234,217

(22) Filed: Jun. 10, 2025

Related U.S. Application Data
(60) Provisional application No. 63/666,010, filed on Jun. 28, 2024.

(51) Int. Cl. G06F 3/06

(52) U.S. Cl. CPC G06F 3/0619; G06F 3/0659; G06F 3/0679

(57) ABSTRACT

Methods, systems, and devices for zoned random write operations are described. A memory system may receive a set of write commands associated with respective logical block addresses (LBAs) that may be in a sequential order, where the respective LBAs may be associated with a zone. The memory system may write first data to a first physical block address (PBA), where the first data may be associated with a first LBA of the respective LBAs. The memory system may determine whether a second LBA associated with second data is sequential relative to a write pointer associated with the zone. The memory system may write the second data to a second PBA that may be sequential to the first PBA in response to determining that the second logical block address is non-sequential relative to the write pointer and on a value of a bitmap corresponding to the second LBA.

### CROSS REFERENCE

The present application for patent claims priority to U.S. Patent Application No. 63/666,010 by Porzio et al., entitled “ZONED RANDOM WRITE OPERATIONS,” filed Jun. 28, 2024, which is assigned to the assignee hereof, and which is expressly incorporated by reference in its entirety herein.

### TECHNICAL FIELD

The following relates to one or more systems for memory, including zoned random write operations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports zoned random write operations in accordance with examples as disclosed herein.

FIG. 2 shows an example of a system that supports zoned random write operations in accordance with examples as disclosed herein.

FIG. 3 shows an example of a process that supports zoned random write operations in accordance with examples as disclosed herein.

FIG. 4 shows an example of a process that supports zoned random write operations in accordance with examples as disclosed herein.

FIG. 5 shows an example of a process that supports zoned random write operations in accordance with examples as disclosed herein.

FIG. 6 shows an example of a process that supports zoned random write operations in accordance with examples as disclosed herein.

FIG. 7 shows a block diagram of a memory system that supports zoned random write operations in accordance with examples as disclosed herein.

FIG. 8 shows a flowchart illustrating a method or methods that support zoned random write operations in accordance with examples as disclosed herein.

### DETAILED DESCRIPTION

In some examples, a memory system may be configured with a set of zones associated with storing data. For instance, a given zone may be associated with a set of sequential logical block addresses (LBAs) that are associated with a set of memory cells. In some examples, the memory system may be configured with one or more zoned storage protocols, where the memory system may operate in accordance with a sequential order of write requests. For instance, if the memory system receives (e.g., from a host system) a write command out of order (e.g., having non-sequential LBAs), then the memory system may reject the write command. Ensuring the sequential ordering of write commands may increase write latency for high traffic operations. However, in some instances it may be difficult to ensure the sequentiality of write commands, or to rebuild non-sequential write commands received by a host system. As such, the occurrence of write command rejection may increase. Accordingly, a memory system operating using a zoned protocol that is configured to receive and process non-sequential write commands may be desirable.

A memory system configured to operate using a zoned protocol and receive and process non-sequential write commands is described herein. In some examples, the memory system may operate in accordance with a write counter and a bitmap for each zone. For instance, the memory system may use a write counter to count the received write commands (e.g., for a given zone). The write counter may be associated with a threshold value that corresponds to the size of the respective zone. Additionally, or alternatively, the memory system may use a bitmap to indicate which LBAs (e.g., for a given zone) have or have not been received. That is, a bitmap may include an entry for each LBA associated with a respective zone. Thus, if a write command is received, the memory system may determine whether the value of the write counter for the respective zone satisfies the threshold value. If the threshold value is satisfied, the zone is open (e.g., available) and may be written to.

The memory system may write data to one or more physical block addresses of the memory system that correspond to the LBAs. If the memory system attempts to write data to non-sequential LBAs (e.g., sequential physical block addresses corresponding to non-sequential LBAs), the memory system may read the bitmap for the respective zone. If the entry corresponding to the non-sequential LBA indicates that the LBA has not been received (e.g., has not been written), then the data may be written to the corresponding physical block address of the memory system. If, however, the entry indicates that the LBA has been previously received, the data may be rejected (e.g., not written to the corresponding physical block). Accordingly, the methods described herein may allow for memory systems operating according to a zoned storage protocol to process non-sequential write commands, which may improve the overall performance of the associated memory system.

In addition to applicability in memory systems as described herein, techniques for zoned random write operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by increasing write speeds at the memory system, which may decrease processing or latency times, improve response times, or otherwise improve user experience, among other benefits.

Features of the disclosure are illustrated and described in the context of systems, devices, and circuits. Features of the disclosure are further illustrated and described in the context of processes and flowcharts.

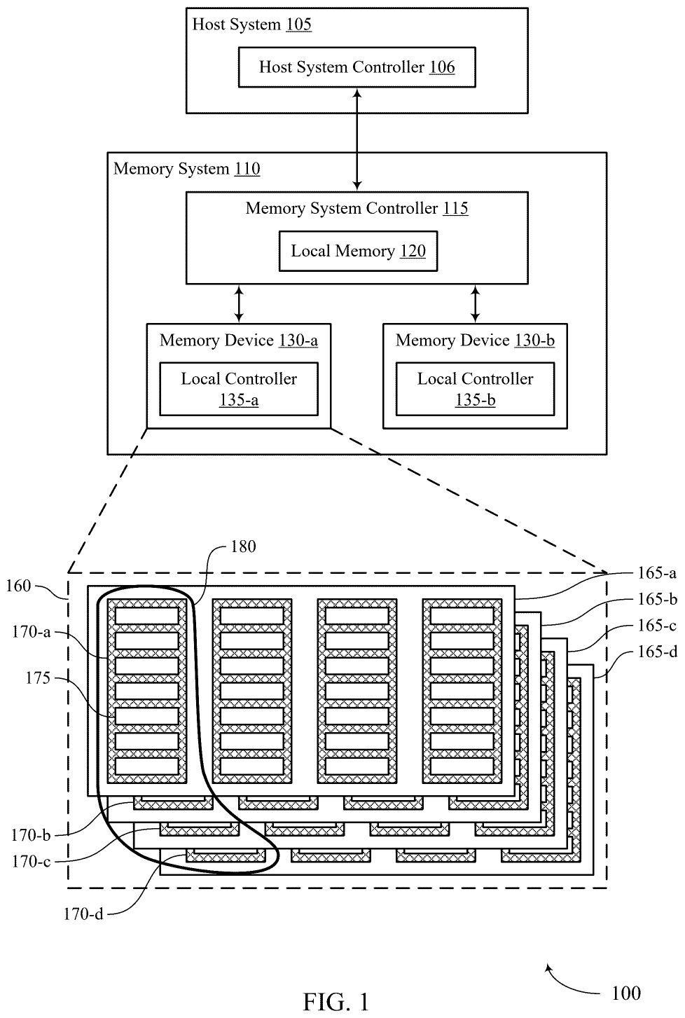

FIG. 1 shows an example of a system 100 that supports zoned random write operations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some examples, the memory system 110 may operate in accordance with a write counter and a bitmap for each zone. For instance, the memory system 110 may use a write counter to count the received write commands (e.g., for a given zone). The write counter may be associated with a threshold value that corresponds to the size of the respective zone. Additionally, or alternatively, the memory system 110 may use a bitmap to indicate which LBAs (e.g., for a given zone) have or have not been received (e.g., from the host system 105). That is, a bitmap may include an entry for each LBA associated with a respective zone. Thus, if a write command is received, the memory system controller 115 may determine whether the value of the write counter for the respective zone satisfies the threshold value. If the threshold value is satisfied, the zone is open (e.g., available) and may be written to.

The memory system controller 115 may write data to one or more physical block addresses of the memory system 110 that correspond to the LBAs. If the memory system controller 115 attempts to write data to non-sequential LBAs (e.g., sequential physical block addresses corresponding to non-sequential LBAs), the memory system controller 115 may read the bitmap for the respective zone. If the entry corresponding to the non-sequential LBA indicates that the LBA has not been received (e.g., has not been written), then the data may be written to the corresponding physical block address of the memory device 130. If, however, the entry indicates that the LBA has been previously received, the data may be rejected (e.g., not written to the corresponding physical block of the memory device 130). Accordingly, the methods described herein may allow for memory systems operating according to a zoned storage protocol to process non-sequential write commands, which may improve the overall performance of the associated memory system 110.

The system 100 may include any quantity of non-transitory computer readable media that support zoned random write operations. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

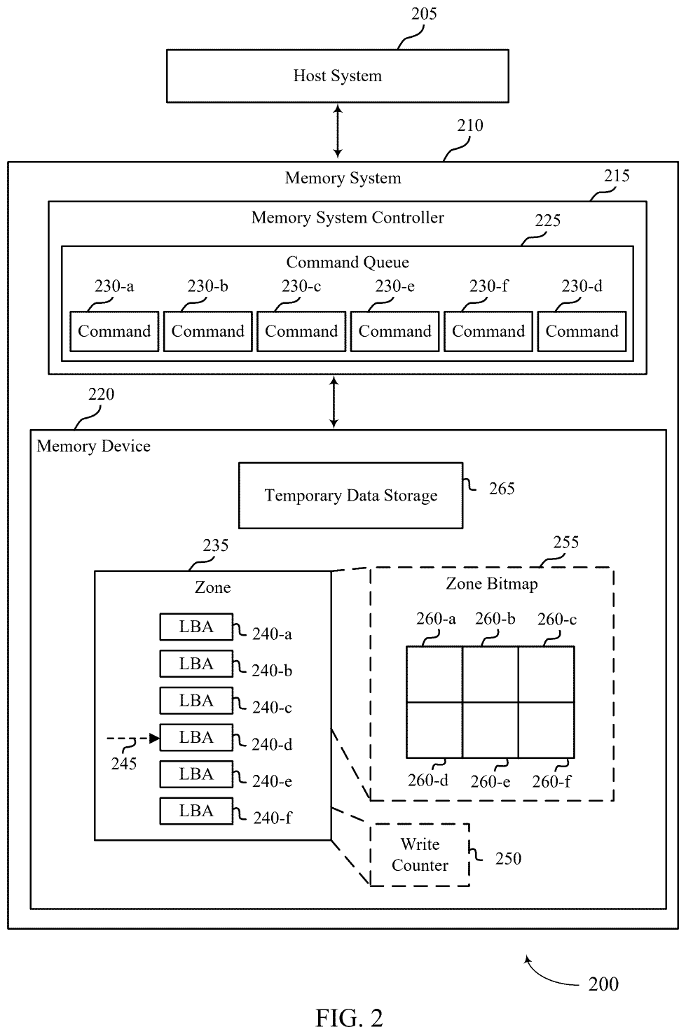

FIG. 2 shows an example of a system 200 that supports zoned random write operations in accordance with examples as disclosed herein. The system 200 may include a host system 205 and a memory system 210. In some instances, the memory system 210 may include a memory system controller 215 and a memory device 220, which may be examples of the corresponding devices described with respect to FIG. 1. In some examples, the memory system controller 215 may be configured to receive one or more write commands 230. The system 200 may operate according to a zoned storage protocol to process non-sequential write commands, which may improve its overall performance.

As illustrated in FIG. 2, the memory device 220 may include a zone 235. In some examples, the memory device 220 may be a NAND device (e.g., a NAND flash device), such that the memory device 220 may be configured with multiple zones 235. For example, each zone 235 may include or correspond to a set of memory cells. For instance, each zone 235 may be associated with a set of LBAs 240, that are associated with a set of memory cells. As illustrated in FIG. 2, zone 235 may include a first respective set of LBAs 240 (e.g., LBA 240-a, 240-b, 240-c, 240-d, 240-e, and 240-f). While FIG. 2 illustrates a single zone 235 with six LBAs 240, it is understood that the memory device 220 may include any quantity of zones 235 where each zone 235 includes any quantity of LBAs 240.

In some examples, each LBA 240 of the zone 235 may correspond to a respective physical address of the memory device 220 (e.g., a respective physical block address (PBA)). A PBA may represent a physical location of the memory device 220. For instance, a PBA may point to (e.g., correspond or be associated with) an address of a page (e.g., a page 175) that includes a set of memory cells for a zone 235. As such, an LBA 240 may serve as an abstraction for the host system 205 to interact with the storage devices, while a PBA points to the actual location of a set of memory cells for storage of data. In some examples, accessing data stored to a PBA using the associated LBA 240 may utilize an entry or record that assigns a mapping between each LBA 240 and each PBA (e.g., a logical-to-physical (L2P) table). Additionally, or alternatively, a mapping between an LBA 240 and a PBA may change over time. For instance, the LBA 240-a may be mapped to a first PBA at a first time and at a second time, the memory system controller 215 may transfer the contents of the first PBA to a second PBA and map the LBA 240-a to the second PBA. As such, a contiguous set of LBAs 240 (e.g., LBA 240-a through 240-f) may map to a contiguous or a non-contiguous set of PBAs of the memory device 220.

In some examples, the zone 235 of memory device 220 may be associated with one or more zoned storage protocols (such as a zoned namespace (ZNS)). For example, the memory device 220 may be an example of a solid-state drive (SSD) or a universal flash storage (UFS) device, and such zoned storage protocols may organize the memory device 220 into zones 235, enabling more efficient data handling. For instance, the memory system controller 215 may divide the data storage of the memory device 220 into a quantity of zones 235, where each zone 235 is associated with a quantity of sequential LBAs 240. As such, zone-based data partitioning may enable the host system 205 to write data sequentially within a zone 235 (e.g., across a sequential set of LBAs 240). By writing data sequentially, the system 200 may reduce the occurrence of maintenance operations (e.g., garbage collection operations) associated with disordered data, which may reduce write amplification, thus increasing the longevity of the memory cells of the memory device 220.

As illustrated in FIG. 2, the host system 205 may write data to the memory device 220 in accordance with transmitting one or more commands (e.g., write commands 230). For example, the memory system controller 215 may receive a set of write commands 230 (e.g., write command 230-a, 230-b, 230-c, 230-d, 230-e, and 230-f) associated with respective LBAs 240 that are in a sequential order. That is, the memory system controller 215 may receive LBAs 240 of the write commands 230 in a sequential order. In the example of FIG. 2, write command 230-a through 230-f may be associated with writing data respectively to LBA 240-a through 240-f. As such, the memory system controller 215 may receive the set of write commands 230 at a command queue 225.

Additionally, the memory system controller 215 may determine correspondence between a given write command 230 and an LBA 240 in accordance with a location of a write pointer 245. For example, the memory system controller 215 may configure a write pointer 245 that points to the next available LBA 240 for writing. That is, in response to opening the zone 235, the write pointer 245 may be associated with (e.g., point to) LBA 240-a. As such, the memory system controller 215 may select write command 230-a from the command queue 225 and write the associated data to the LBA 240-a. In response to writing data of write command 230-a to the LBA 240-a, the memory system controller 215 may increment the write pointer 245 to LBA 240-b, indicating that LBA 240-b is the next available sequential LBA 240 for writing data to.

Additionally, or alternatively, the memory system controller 215 may reject a write command 230 that is not associated with the LBA 240 the write pointer 245 is pointing to. For instance, in the example of FIG. 2, the write pointer 245 is currently pointing to LBA 240-d (e.g., it is assumed that memory system controller 215 successfully wrote the data from write command 230-a, 230-b, and 230-c to LBA 240-a, 240-b, and 240-c respectively). However, as illustrated in FIG. 2, the set of write commands 230 are not sequentially ordered at the command queue 225 (e.g., write command 230-e and 230-f are queued before write command 230-d). To maintain sequential ordering of data at the zone 235, the memory system controller 215 may reject write command 230-e and 230-f and proceed to writing the data of write command 230-d to LBA 240-d. In some examples, the memory system controller 215 may indicate to the host system 205 rejection of write command 230-e and 230-f, and in response the host system 205 may retransmit write command 230-e and 230-f to the command queue 225.

As such, the write pointer 245 may ensure a sequential order of write commands 230 from the host system 205. In some cases, however, ensuring the sequential ordering of write commands 230 may increase write latency for high traffic operations. For example, the host system 205 may be associated with a high queue depth (e.g., a quantity of write commands 230 above a threshold), and as the queue depth increases the probability of non-sequential write commands 230 may increase. As such, the occurrence of write command 230 rejection may increase, increasing complexity at the host system 205 to rebuild and resubmit rejected write commands 230 to the command queue 225. Additionally, or alternatively, different types of systems 200 may be associated with different occurrence levels of non-sequential write commands 230. For instance, the host system 205 may be associated with multiple processing cores, where each processing core may concurrently generate write commands 230 for the host system 205 to submit to the command queue 225, further increasing the probability of non-sequential write commands 230 at the command queue 225. As such, it may be advantageous for the memory system controller 215 to tolerate (e.g., process) a threshold level of non-sequential write commands 230.

The system 200 may be configured to process a threshold level of non-sequential write commands 230 to increase write performance of the memory device 220. In some examples, the memory system controller 215 may operate in accordance with a write counter 250. For instance, the memory system controller 215 may use a write counter 250 to count the received write commands 230 and may allow write commands 230 to be executed in a non-sequential order. In some examples, the memory system controller 215 may use the write counter 250 instead of or in addition to the write pointer 245. The write counter may be associated with a threshold value that corresponds to the size of the zone 235. If the value of the counter satisfies threshold, the zone 235 may be available (e.g., written to), whereas if the value of the counter does not satisfy (e.g., exceeds) the threshold, the zone 235 may be closed.

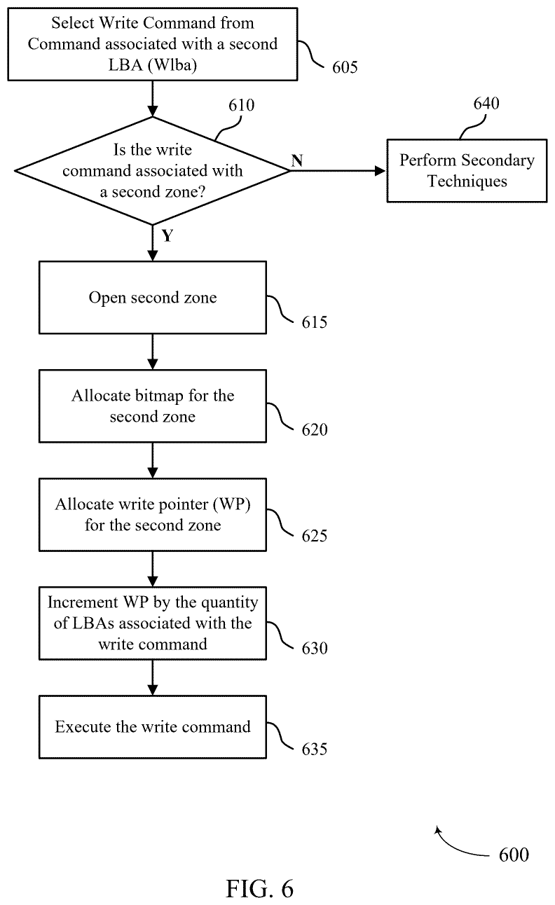

In examples of using the write counter 250, the memory system controller 215 may configure a given write counter 250 for each open zone 235. That is, if the memory device 220 is associated with six open zones 235, the memory system controller 215 may maintain a respective write counter 250 for each of the six open zones 235. For cases of using the write counter 250, the memory system controller 215 may operate in accordance with a write management procedure. For example, the memory system controller 215 may determine whether a selected write command 230 is associated with an open zone 235, according to one or more protocol rules. If the write command 230 is not associated with an open zone 235, then the memory system controller 215 may open a zone 235 for the write command 230. Further discussion of whether to open a zone 235 in accordance with the one or more protocol rules is described herein, including with reference to FIG. 6.

In response to identifying which zone 235 the write command 230 is associated with, the memory system controller 215 may increment the associated write counter 250 by the quantity of data associated with the write command 230. For instance, while FIG. 2 illustrates a case where each write command 230 is associated with writing data to a single LBA 240 (e.g., LBA 240-a is written with data from write command 230-a), it is understood that a given write command 230 may be associated with writing data to multiple sequential LBAs 240 of a zone 235. As such, the memory system controller 215 may increment the write counter 250 by the quantity of LBAs 240 the write command 230 is associated with writing data to.

In response to incrementing the write counter 250, the memory system controller 215 may determine whether the write counter 250 satisfies (e.g., is less than or equal to) a threshold value (e.g., a zone size associated with zone 235). For instance, the zone size may be associated with the quantity of LBAs 240 included in the zone 235, such that if the write counter 250 does not satisfy (e.g., is greater than) the zone size, then the memory system controller 215 may reject (e.g., refuse) the write command 230. In response to rejecting the write command 230, the memory system controller 215 may transmit an indication to the host system 205 indicating the write command 230 has been rejected. As such, the host system 205 may determine to regenerate the write command 230 for association with LBAs 240 corresponding to a different zone 235 and transmit the regenerated write command 230 to the command queue 225.

If the memory system controller 215 determines that the write counter 250 does satisfy the threshold (e.g., the zone size), the memory system controller 215 may execute the write command 230. In some examples of executing the write command 230, the memory system controller 215 may write the contents of the write command 230 to a temporary data storage 265. For instance, the temporary data storage 265 may be a portion of the memory device allocated for temporary storage of data that may be later transferred to the corresponding set of LBAs 240. In some examples, the temporary data storage 265 may be a temporary cache of volatile memory cells. In other examples, the temporary data storage 265 may be a NAND array. In response to executing the write command 230, the memory system controller 215 may advance the location of the write pointer 245 to the next available (e.g., empty) LBA 240 of the zone 235. In response to advancing the location of the write pointer 245, the memory system controller 215 may transmit to the host system 205 an indication that the data of the write command 230 was successfully written.

Additionally, or alternatively, the memory system controller 215 may operate in accordance with a zone bitmap 255 (e.g., a zone allocation bitmap). For instance, the memory system controller 215 may maintain a zone bitmap 255 for each zone 235, where each index 260 of the zone bitmap 255 may be associated with a respective LBA 240 of the zone 235. The memory system controller 215 may use the zone bitmap 255 in conjunction with the write pointer 245, such that if the write pointer 245 position does not correspond to the next write command 230, the memory system controller 215 may analyze (e.g., read) the zone bitmap 255 to determine if an exception may be made. That is, the zone bitmap 255 may track the non-sequential ordering exceptions.

In examples of using the zone bitmap 255, the memory system controller 215 may configure one or more bitmaps for each open zone 235 at the memory device 220. For example, the quantity of zone bitmaps 255 for a given zone 235 may be equal to or associated with a quantity of logical pages in the given zone 235. That is, if the zone size for the zone 235 is 1 GB, then the zone bitmap 255 may be 32 KB. As illustrated in FIG. 2, each index 260 of the zone bitmap 255 may be associated with a respective LBA 240 of the zone 235. For example, index 260-a may be associated with LBA 240-a, index 260-b may be associated with LBA 240-b, index 260-c may be associated with LBA 240-c, index 260-d may be associated with LBA 240-d, index 260-e may be associated with LBA 240-e, and index 260-f may be associated with LBA 240-f.

In some examples, each index 260 may store a bit value, such that the zone bitmap 255 may be an array of bits stored at the memory device 220. In some examples, an index 260 being of a first value (e.g., a bit value of 0 or 1) may indicate that the associated LBA 240 is empty, and an index 260 being of a second value (e.g., the bit value opposite of the first value) may indicate that the memory system controller 215 has written data (e.g., to the temporary data storage 265) associated with the LBA 240. As described herein, memory system controller 215 may determine if an LBA 240 associated with a selected write command 230 corresponds to a current location of the write pointer 245 and, in response to the determination, perform one or more protocols associated with the zone bitmap 255.

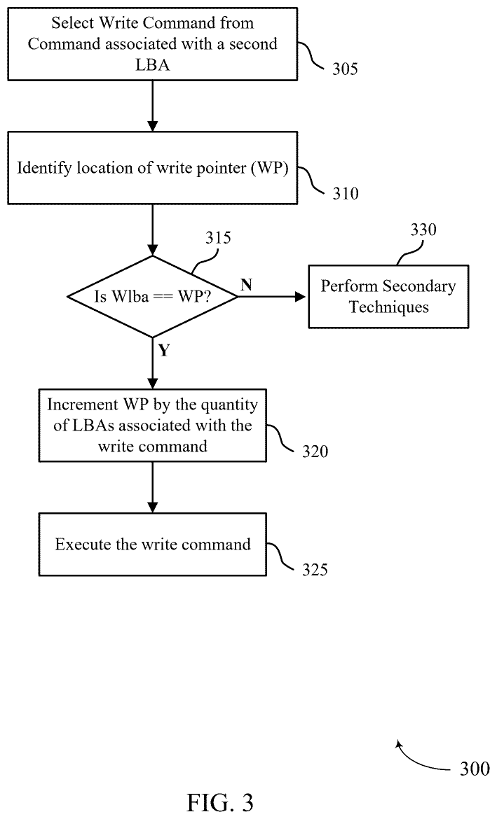

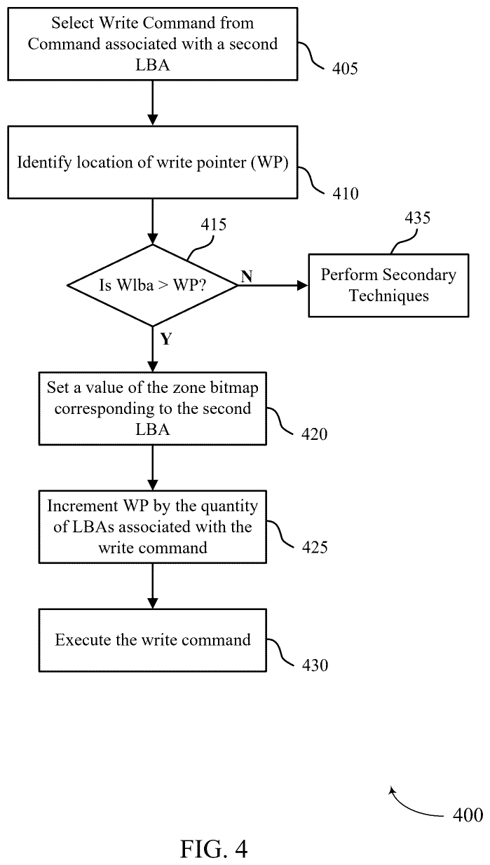

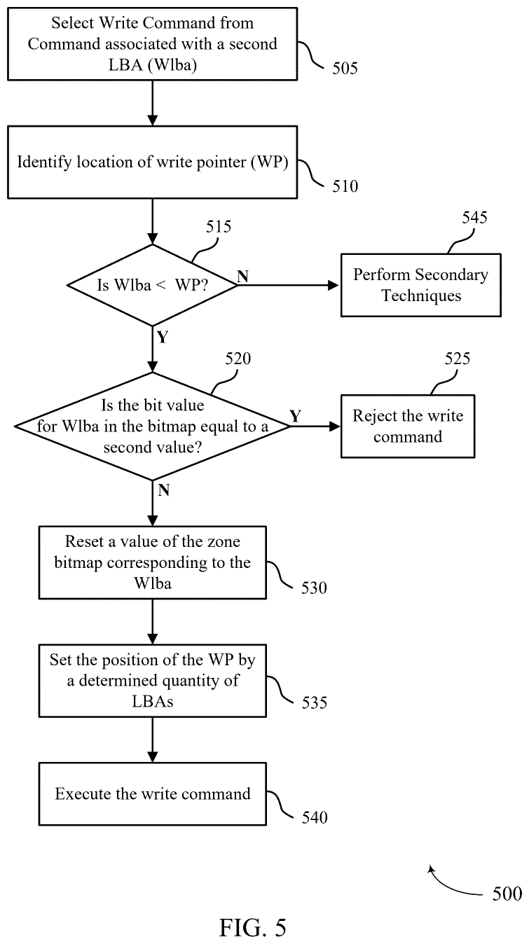

If the LBA 240 associated with the selected write command 230 is at the current location of the write pointer 245, the memory system controller 215 may operate in accordance with techniques described with reference to FIG. 3. If the LBA 240 associated with the selected write command 230 is greater than the current location of the write pointer 245, the memory system controller 215 may operate in accordance with techniques described with reference to FIG. 4. If the LBA 240 associated with the selected write command 230 is less than the current location of the write pointer 245, the memory system controller 215 may operate in accordance with techniques described with reference to FIG. 5.

In some examples, the size of the zone bitmap 255 (e.g., the bitmap array size) may be dependent (e.g., linearly dependent) on the zone size of the associated zone 235. That is, as a zone size increases, the size of the associated zone bitmap 255 may also increase. As such, the memory system 210 may operate in accordance with one or more compression techniques to reduce the size of a given zone bitmap 255. For example, the memory system controller 215 may use a run-length encoding (RLE) technique such that sequences of a same data are stored as a single data value and count. For instance, if index 260-a through 260-d are associated with the second value and index 260-e and 260-f are associated with the first value, the memory system controller 215 may indicate that the first four indexes 260 store the second value and that the last two indexes 260 store the first value (e.g., [4, ‘second value’], [2, ‘first value’]). As such, the compression techniques descried herein may reduce the data size associated with storing the zone bitmap 255.

Additionally, or alternatively, the memory system controller 215 may configure the zone bitmap 255 to be associated with a portion of the zone 235. For instance, the memory system controller 215 may determine to retain the zone bitmap 255 for a first portion of sequential LBAs 240 of the zone 235 (e.g., LBA 240-d, 240-e, and 240-f), and to not retain a zone bitmap 255 for a second portion of LBAs 240 of the zone 235 (e.g., LBA 240-a, 240-b, and 240-c). By configuring a zone bitmap 255 for a portion of the zone 235, the memory system controller 215 may reduce latency associated with analyzing the zone bitmap 255 for portions of the zone 235 that may be associated with lower levels of non-sequential write commands 230 (e.g., traffic disorder is below a threshold).

As described herein, for operations in accordance with write counter 250 and operations in accordance with the zone bitmap 255, the memory system controller 215 may initially store the data for the executed write commands 230 to the temporary data storage 265. For instance, the memory system controller 215 may write data associated with non-sequential LBAs of the commands 230 to the temporary data storage 265. That is, the memory system controller 215 may write the data to the temporary data storage 265 in the order of write commands 230-a, 230-b, 230-c, 230-e, 230-f, and 230-d (e.g., corresponding to non-sequential LBAs 240-a, 240-b, 240-c, 240-e, 240-f, and 240-d). The data may later be written to the memory device in the order of 230-a, 230-b, 230-c, 230-d, 230-e, and 230-f (e.g., corresponding to sequential LBAs 240-a, 240-b, 240-c, 240-d, 240-e, and 240-f).

In other examples, the memory system controller 215 may write the data associated with the non-sequential LBAs directly to the memory device 220 (e.g., not to the temporary storage 265). In such an example, the memory system controller 215 may perform a maintenance operation (e.g., a garbage collection operation) to order the data sequentially. In some examples, the memory system controller 215 may determine to perform the maintenance operation during background operations of the system 200.

By utilizing the write counter 250, the zone bitmap 255, or both, the memory system controller 215 may tolerate a level of non-sequential write commands 230 at the command queue 225. As such, the memory system controller 215 may reduce the instances of rejecting write commands 230. Such techniques may reduce the occurrence of the memory system controller 215 indicating a write command 230 rejection and the host system 205 retransmitting the rejected write command 230 to the command queue 225, which may reduce protocol signal overhead. Moreover, by operating according to a zoned storage protocol to process non-sequential write commands, the overall performance of the memory system 210 may be improved.

FIG. 3 shows an example of a process 300 that supports zoned random write operations in accordance with examples as disclosed herein. In some examples, the process 300 may be implemented by one or more aspects of systems 100 and 200. For instance, the process 300 may be implemented by a memory system 110 or 210 described with reference to FIGS. 1 and 2, respectively.

In some examples, prior to the start of process 300, the memory system may receive a set of write commands associated with respective LBAs that are in a sequential order, where the respective LBAs are associated with a zone of the memory system that includes the set of sequential LBAs. Additionally, the memory system may write first data to a first PBA in response to receiving the set of write commands, where the first data is associated with a first LBA. As such, process 300 may correspond to one or more operations performed by the memory system to identify whether a second LBA associated with second data is sequential relative to a write pointer associated with the zone that includes the set of sequential LBAs.

Aspects of the process 300 may be implemented by one or more controllers, among other components. Additionally, or alternatively, aspects of the process 300 may be implemented as instructions stored in one or more memories (e.g., firmware stored in one or more memories coupled with memory system 110 or 210). For example, the instructions, if executed by one or more controllers (e.g., the memory system controller 115 or 215), may cause the one or more controllers (or a device or a system) to perform the operations of the process 300.

At 305, a write command may be selected. For example, the memory system controller may select a write command from the command queue associated with the second LBA (e.g., a Wlba). In some examples, the write command may be associated with a quantity of sequential LBAs (e.g., Wchunk), where the second LBA is a starting LBA of the quantity of sequential LBAs.

At 310, a location of the write pointer may be identified. For example, the memory system controller may identify the location of the write pointer within the zone. As described, with reference to FIG. 2, the write pointer may indicate a position within the set of sequential LBAs of the zone for writing data.

At 315, a determination may be made. For example, the memory system controller may determine whether the second LBA (e.g., associated with the second data) is sequential relative to the write pointer associated with the zone. That is the memory system controller may determine whether the second LBA is at the position of the write pointer.

At 320, the write pointer may be incremented. For example, if the second LBA is at the position of the write pointer, then the memory system controller may increment the position of the write pointer in response to the second LBA. In some examples, the memory system controller may increment the position of the write pointer by the quantity of sequential LBAs associated with the selected write command (e.g., increment the write pointer by Wchunk).

At 325, the write command may be executed. For example, the memory system controller may write the second data associated with the second LBA to a second PBA in the memory system that is sequential to the first PBA in response to the second LBA being at the position of the write pointer. In some examples, the memory system controller may initially write the second data to a temporary data storage, and as part of a maintenance operation, transfer the second data to the second PBA associated with the second LBA.

At 330, secondary techniques may be performed. For example, if the second LBA is not at the position of the write pointer, then the memory system controller may determine to perform the secondary techniques. For instance, if the second LBA is greater than the position of write pointer, then the memory system controller may operate in accordance with the techniques of FIG. 4. If the second LBA is less than the position of the write pointer, then the memory system controller may operate in accordance with the techniques of FIG. 5.

FIG. 4 shows an example of a process 400 that supports zoned random write operations in accordance with examples as disclosed herein. In some examples, the process 400 may be implemented by one or more aspects of systems 100 and 200. For instance, the process 400 may be implemented by a memory system 110 or 210 described with reference to FIGS. 1 and 2, respectively.

In some examples, prior to the start of process 400, the memory system may receive a set of write commands associated with respective LBAs that are in a sequential order, where the respective LBAs are associated with a zone of the memory system that includes the set of sequential LBAs. Additionally, the memory system may write first data to a first PBA in response to receiving the set of write commands, where the first data is associated with a first LBA. As such, process 400 may correspond to one or more operations performed by the memory system to identify whether a second LBA associated with second data is sequential relative to a write pointer associated with the zone that includes the set of sequential LBAs.

Aspects of the process 400 may be implemented by one or more controllers, among other components. Additionally, or alternatively, aspects of the process 400 may be implemented as instructions stored in one or more memories (e.g., firmware stored in one or more memories coupled with memory system 110 or 210). For example, the instructions, if executed by one or more controllers (e.g., the memory system controller 115 or 215), may cause the one or more controllers (or a device or a system) to perform the operations of the process 400.

At 405, a write command may be selected. For example, the memory system controller may select a write command from the command queue associated with the second LBA (e.g., a Wlba). In some examples, the write command may be associated with a quantity of sequential LBAs (e.g., Wchunk), where the second LBA is a starting LBA of the quantity of sequential LBAs.

At 410, a location of the write pointer may be identified. For example, the memory system controller may identify the location of the write pointer within the zone. As described, with reference to FIG. 2, the write pointer may indicate a position within the set of sequential LBAs of the zone for writing data.

At 415, a determination may be made. For example, the memory system controller may determine whether the second LBA (e.g., associated with the second data) is non-sequential relative to the write pointer associated with the zone. That is, the memory system controller may determine whether the second LBA is greater than the position of the write pointer.

At 420, a value of the zone bitmap may be set. For example, if the second LBA is greater than the position of the write pointer, then the memory system controller may set a value of the zone bitmap corresponding to the second LBA (e.g., the index associated with Wlba). In some examples, the memory system controller may set the index of the second LBA to the second value (e.g., as described in FIG. 2), where the second value indicates that the second LBA is filled. In some examples, the memory system controller may set a respective index associated with each of the quantity of sequential LBAs associated with the selected write command, to the second value.

At 425, the write pointer may be incremented. For example, the memory system controller may increment the position of the write pointer in response to setting the index of the bitmap associated with second LBA to the second value. In some examples, the memory system controller may increment the position of the write pointer by the quantity of sequential LBAs associated with the selected write command (e.g., increment the write pointer by Wchunk).

At 430, the write command may be executed. For example, the memory system controller may write the second data associated with the second LBA to a second PBA in the memory system that is sequential to the first PBA in response to determining that the second LBA is non-sequential relative to the write pointer and on a value of the zone bitmap corresponding to the second LBA.

In some examples, the memory system controller may initially write the data associated with the set of commands to a temporary data storage, and as part of a maintenance operation, transfer the data to the corresponding sequential LBAs. For example, during the maintenance operation, the memory system controller may write a third data and a fourth data to sequential PBAs of the memory system, where the third data and the fourth data are associated with sequential LBAs and were written to non-sequential PBAs prior to the maintenance operation.

At 435, secondary techniques may be performed. For example, if the second LBA is not greater than the write pointer, then the memory system controller may determine to perform the secondary techniques. For instance, if the second LBA is at the position of the write pointer, then the memory system controller may operate in accordance with the techniques of FIG. 3. If the second LBA is less than the position of the write pointer, then the memory system controller may operate in accordance with the techniques of FIG. 5.

FIG. 5 shows an example of a process 500 that supports zoned random write operations in accordance with examples as disclosed herein. In some examples, the process 500 may be implemented by one or more aspects of systems 100 and 200. For instance, the process 500 may be implemented by a memory system 110 or 210 described with reference to FIGS. 1 and 2, respectively.

In some examples, prior to the start of process 500, the memory system may receive a set of write commands associated with respective LBAs that are in a sequential order, where the respective LBAs are associated with a zone of the memory system that includes the set of sequential LBAs. Additionally, the memory system may write first data to a first PBA in response to receiving the set of write commands, where the first data is associated with a first LBA. As such, process 500 may correspond to one or more operations performed by the memory system to identify whether a second LBA associated with second data is sequential relative to a write pointer associated with the zone that includes the set of sequential LBAs.

Aspects of the process 500 may be implemented by one or more controllers, among other components. Additionally, or alternatively, aspects of the process 500 may be implemented as instructions stored in one or more memories (e.g., firmware stored in one or more memories coupled with memory system 110 or 210). For example, the instructions, if executed by one or more controllers (e.g., the memory system controller 115 or 215), may cause the one or more controllers (or a device or a system) to perform the operations of the process 500.

At 505, a write command may be selected. For example, the memory system controller may select a write command from the command queue associated with the second LBA (e.g., a Wlba). In some examples, the write command may be associated with a quantity of sequential LBAs (e.g., Wchunk), where the second LBA is a starting LBA of the quantity of sequential LBAs.

At 510, a location of the write pointer may be identified. For example, the memory system controller may identify the location of the write pointer within the zone. As described, with reference to FIG. 2, the write pointer may indicate a position within the set of sequential LBAs of the zone for writing data.

At 515, a determination may be made. For example, the memory system controller may determine whether the second LBA (e.g., associated with the second data) is non-sequential relative to the write pointer associated with the zone. That is, the memory system controller may determine whether the second LBA is less than the position of the write pointer.

At 520, a second determination may be made. For example, if the Wlba is less than the position of the write pointer, then the memory system controller may determine whether a bit value associated second LBA in the zone bitmap is equal to a second value. In some examples, the memory system controller may determine if a respective bit value associated with each of quantity of sequential LBAs associated with the selected write command are equal to the second value.

At 525, the selected write command may be rejected. For example, if the bit value for the second LBA in the zone bitmap is equal to the second value, then the memory system controller may reject the selected write command. For instance, the bit value being of the second value may indicate that the memory system controller has previously written data associated with the second LBA, and as such, performing the selected write command would overwrite the previously written data. As such, the memory system controller may reject the selected write command to maintain the data previously written to the second LBA. That is, the memory system controller may refrain from writing the second data to the second PBA of the memory system in response to the value of the bitmap corresponding to the second LBA including the second value. In some examples, the memory system controller may reject the selected write command if any of the quantity of sequential LBAs associated with the selected write command have an associated bit value in the zone bitmap of the second value.

At 530, a value of the zone bitmap may be reset. For example, if the bit value for the second LBA in the zone bitmap is not equal to the second value (e.g., equal to the first value), then the memory system controller may reset the value of the zone bitmap corresponding to the second LBA. In some examples, the memory system controller may reset if the respective bit value associated with each of quantity of sequential LBAs associated with the selected write command.

At 535, the position of the write pointer may be set. For example, the memory system controller may set the portion of the write pointer in response to resetting the value of the zone bitmap corresponding to the second LBA. In some examples, the memory system controller may set the write pointer to the greater of two values, where the first value may be the position of the second LBA plus the quantity of sequential LBAs associated with the selected write command (e.g., Wlba+Wchunk) and the second value may be the current position of the write pointer.

At 540, the write command may be executed. For example, the memory system controller may write the second data associated with the second LBA to a second PBA in the memory system that is sequential to the first PBA in response to determining that the Wlba is non-sequential relative to the write pointer and on a value of the zone bitmap corresponding to the Wlba.

In some examples, the memory system controller may initially write the data associated with the set of commands to a temporary data storage, and as part of a maintenance operation, transfer the data to the corresponding sequential LBAs. For example, during the maintenance operation, the memory system controller may write a third data and a fourth data to sequential PBAs of the memory system, where the third data and the fourth data are associated with sequential LBAs and were written to non-sequential PBAs prior to the maintenance operation.

At 545, secondary techniques may be performed. For example, if the second LBA is not less than the position of the write pointer, then the memory system controller may determine to perform the secondary techniques. For instance, if the second LBA is at the position of the write pointer, then the memory system controller may operate in accordance with the techniques of FIG. 3. If the second LBA is greater than the position of the write pointer, then the memory system controller may operate in accordance with the techniques of FIG. 4.

FIG. 6 shows an example of a process 600 that supports zoned random write operations in accordance with examples as disclosed herein. In some examples, the process 600 may be implemented by one or more aspects of systems 100 and 200. For instance, the process 600 may be implemented by a memory system 110 or 210 described with reference to FIGS. 1 and 2, respectively. In some examples, prior to the start of process 600, the memory system may receive a set of write commands associated with respective LBAs that are in a sequential order, where the respective LBAs are associated with a first zone of the memory system that includes the set of sequential LBAs. Additionally, the memory system may write first data to a first PBA in response to receiving the set of write commands, where the first data is associated with a first LBA of the first zone. As such, process 600 may correspond to one or more operations performed by the memory system to identify whether a second LBA associated with second data is associated with a second zone.

Aspects of the process 600 may be implemented by one or more controllers, among other components. Additionally, or alternatively, aspects of the process 600 may be implemented as instructions stored in one or more memories (e.g., firmware stored in one or more memories coupled with memory system 110 or 210). For example, the instructions, if executed by one or more controllers (e.g., the memory system controller 115 or 215), may cause the one or more controllers (or a device or a system) to perform the operations of the process 600.

At 605, a write command is selected. For example, the memory system controller may select a write command from the command queue associated with the second LBA (e.g., a Wlba). In some examples, the write command may be associated with a quantity of sequential LBAs (e.g., Wchunk), where the Wlba is a starting LBA of the quantity of sequential LBAs.

At 610, a determination is made. For example, the memory system controller may determine whether the selected write command is associated with the second zone (e.g., a non-opened zone). In some examples, the determination may be explicit. For instance, the selected write command may be or include an open zone command that indicates for the memory system controller to open the second zone, where the Wlba and the quantity of sequential LBAs are associated with the second zone. In some examples, the determination may be implicit. For instance, if the Wlba plus the quantity of sequential LBAs is greater than a remaining quantity of empty LBAs associated with the first zone, then the memory system controller may determine that performing the selected write command to the first zone would overflow the first zone. As such, the memory system controller may implicitly determine that the Wlba and the quantity of sequential LBAs are associated with the second zone.

At 615, the second zone is opened. For example, if the memory system controller determines (e.g., explicitly or implicitly) that the selected write command is associated with the second zone, then the memory system controller may open the second zone. That is the memory system controller may open the second zone in response to receiving the selected write command from the host system.

At 620, a second bitmap is allocated. For example, the memory system controller may allocate a second bitmap to the second zone. In some examples, the second bitmap may be an example of a zone bitmap 255, as described with reference to FIG. 2. For instance, each index of the second bitmap may be associated with an LBA of the second zone. As such, the memory system controller may allocate the second bitmap to the second zone in response to receiving the selected write command from the host system. As described herein, the memory system controller may allocate a bitmap to each open zone at the memory device or allocate a bitmap to a subset of open zones at the memory device, where a given bitmap may include a respective index for each LBA of an associated zone or for a subset of LBAs of the associated zone.

At 625, a second write pointer is allocated. For example, the memory system controller may allocate a second write pointer to the second zone in response to receiving the selected write command from the host system. As described herein, the memory system controller may allocate a respective write pointer for each open zone at the memory device, where a given write pointer indicates a position within a set of sequential LBAs of the associated zone for writing data.

At 630, the second write pointer is incremented. For example, the memory system controller may increment the position of the second write pointer in response to receiving the selected write command from the host system. In some examples, the memory system controller may increment the position of the second write pointer by the quantity of sequential LBAs associated with the selected write command (e.g., increment the write pointer by Wchunk).

At 635, the write command is executed. For example, the memory system controller may write the second data associated with the Wlba to a second PBA in the memory system that is associated with the second zone.

At 640, secondary techniques are performed. For example, if the memory system controller determines (e.g., explicitly or implicitly) that the selected write command is not associated with the second zone, then the memory system controller may determine to perform the secondary techniques. For instance, the memory system controller may compare a position of a first write pointer associated with the first zone to the position of the Wlba. If the Wlba is equal to the write pointer, then the memory system controller may operate in accordance with the techniques of FIG. 3. If the Wlba is greater than the write pointer, then the memory system controller may operate in accordance with the techniques of FIG. 4. If the Wlba is less than the write pointer, then the memory system controller may operate in accordance with the techniques of FIG. 5.

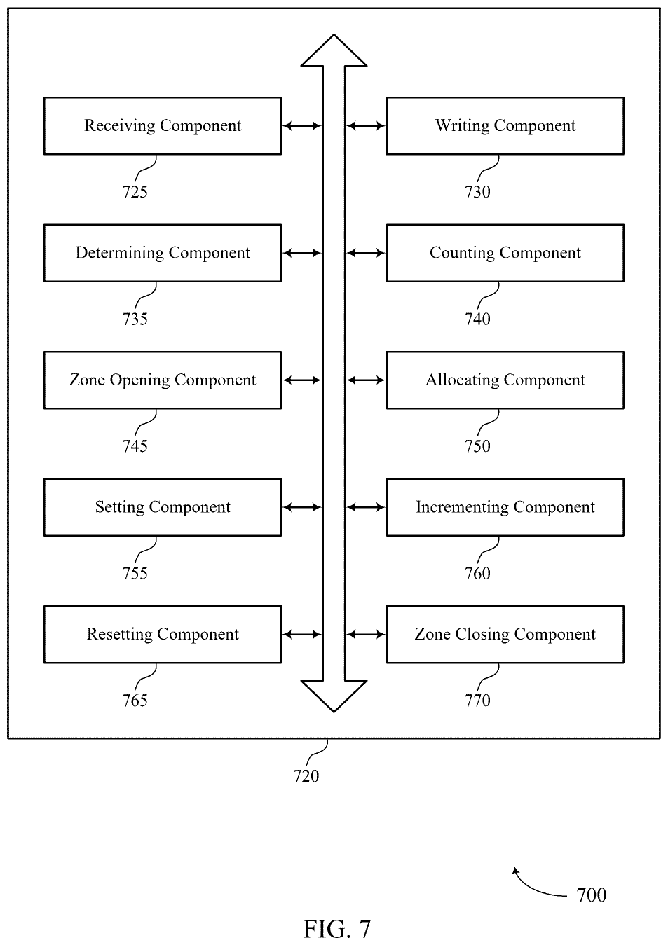

FIG. 7 shows a block diagram 700 of a memory system 720 that supports zoned random write operations in accordance with examples as disclosed herein. The memory system 720 may be an example of aspects of a memory system as described with reference to FIGS. 1 through 6. The memory system 720, or various components thereof, may be an example of means for performing various aspects of zoned random write operations as described herein. For example, the memory system 720 may include a receiving component 725, a writing component 730, a determining component 735, a counting component 740, a zone opening component 745, an allocating component 750, a setting component 755, an incrementing component 760, a resetting component 765, a zone closing component 770, or any combination thereof. Each of these components, or components of subcomponents thereof (e.g., one or more processors, one or more memories), may communicate, directly or indirectly, with one another (e.g., via one or more buses).

The receiving component 725 may be configured as or otherwise support a means for receiving a plurality of write commands associated with respective logical block addresses that are in a sequential order, where the respective logical block addresses are associated with a zone of the memory system that includes a plurality of sequential logical block addresses. The writing component 730 may be configured as or otherwise support a means for writing first data to a first physical block address of the memory system in response to receiving the plurality of write commands, where the first data is associated with a first logical block address of the respective logical block addresses. The determining component 735 may be configured as or otherwise support a means for determining whether a second logical block address associated with second data is sequential relative to a write pointer associated with the zone, where the write pointer indicates a position within the plurality of sequential logical block addresses of the zone for writing data. In some examples, the writing component 730 may be configured as or otherwise support a means for writing the second data to a second physical block address of the memory system that is sequential to the first physical block address in response to determining that the second logical block address is non-sequential relative to the write pointer and on a value of a bitmap corresponding to the second logical block address.

In some examples, the counting component 740 may be configured as or otherwise support a means for incrementing a value of a counter in response to receiving the plurality of write commands. In some examples, the determining component 735 may be configured as or otherwise support a means for determining whether the value of the counter satisfies a threshold value corresponding to the plurality of sequential logical block addresses of the zone, where writing the first data to the first physical block address of the memory system is in response to determining that the value of the counter satisfies the threshold value.

In some examples, the receiving component 725 may be configured as or otherwise support a means for receiving a second plurality of write commands associated with respective logical block addresses in a sequential order. In some examples, the counting component 740 may be configured as or otherwise support a means for incrementing the value of a counter in response to receiving the second plurality of write commands. In some examples, the writing component 730 may be configured as or otherwise support a means for refraining from writing third data associated with a third logical block address to a third physical block address of the memory system in response to determining that the value of the counter fails to satisfy the threshold value.

In some examples, the zone closing component 770 may be configured as or otherwise support a means for closing the zone in response to determining that the value of the counter fails to satisfy the threshold value.

In some examples, the determining component 735 may be configured as or otherwise support a means for determining the value of the bitmap corresponding to the second logical block address in response to determining that the second logical block address is non-sequential relative to the write pointer, where writing the second data to the second physical block address is in accordance with the value of the bitmap corresponding to the second logical block address including a first value.

In some examples, the resetting component 765 may be configured as or otherwise support a means for resetting the value of the bitmap corresponding to the second logical block address in response to writing the second data to the second physical block address.

In some examples, the determining component 735 may be configured as or otherwise support a means for determining that a fourth logical block address associated with fourth data is non-sequential relative to the write pointer associated with the zone. In some examples, the determining component 735 may be configured as or otherwise support a means for determining that the value of the bitmap corresponding to the fourth logical block address includes a second value. In some examples, the writing component 730 may be configured as or otherwise support a means for refraining from writing the fourth data to a fourth physical block address of the memory system in accordance with the value of the bitmap corresponding to the fourth logical block address including the second value.

In some examples, the receiving component 725 may be configured as or otherwise support a means for receiving a third plurality of write commands associated with respective logical block addresses in a sequential order, where the respective logical block addresses are associated with a second zone of the memory system that includes a plurality of sequential logical block addresses. In some examples, the zone opening component 745 may be configured as or otherwise support a means for opening the second zone of the memory system in response to receiving the third plurality of write commands. In some examples, the allocating component 750 may be configured as or otherwise support a means for allocating a second bitmap to the second zone in response to opening the second zone.

In some examples, the writing component 730 may be configured as or otherwise support a means for writing, during a maintenance operation, the first data and fifth data to sequential physical block addresses of the memory system, where the first data and the fifth data are associated with sequential logical block addresses and were written to non-sequential physical block addresses prior to the maintenance operation.

In some examples, the setting component 755 may be configured as or otherwise support a means for setting a value of the bitmap corresponding to the second logical block address to a first value in accordance with the second logical block address being non-sequential relative to the write pointer.

In some examples, the incrementing component 760 may be configured as or otherwise support a means for incrementing the write pointer associated with the zone in response to writing the first data to the first physical block address of the memory system.

In some examples, the first logical block address and the second logical block address are non-sequential logical block addresses.

In some examples, the described functionality of the memory system 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 720, or various components thereof, may be implemented at least in part by instructions (e.g., stored in memory, non-transitory computer-readable medium) executable by such at least one processor.

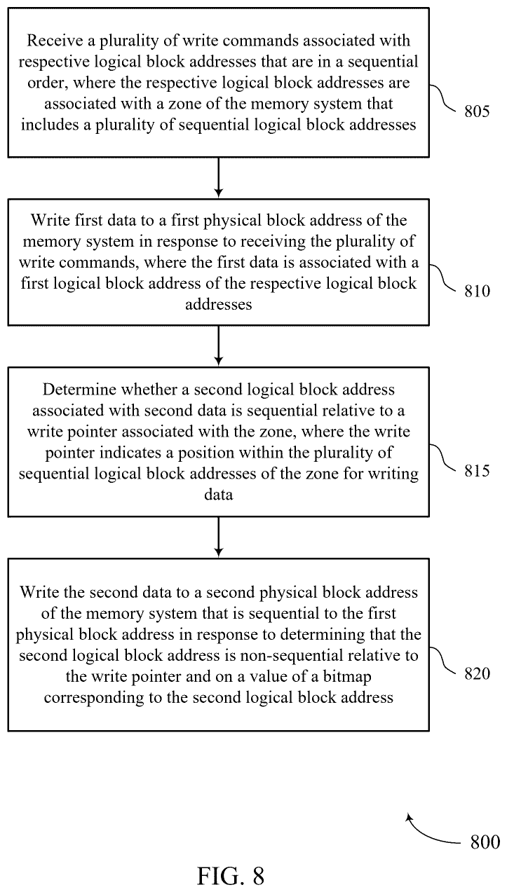

FIG. 8 shows a flowchart illustrating a method 800 that supports zoned random write operations in accordance with examples as disclosed herein. The operations of method 800 may be implemented by a memory system or its components as described herein. For example, the operations of method 800 may be performed by a memory system as described with reference to FIGS. 1 through 7. In some examples, a memory system may execute a set of instructions to control the functional elements of the device to perform the described functions. Additionally, or alternatively, the memory system may perform aspects of the described functions using special-purpose hardware.

At 805, the method may include receiving a plurality of write commands associated with respective logical block addresses that are in a sequential order, where the respective logical block addresses are associated with a zone of the memory system that includes a plurality of sequential logical block addresses. In some examples, aspects of the operations of 805 may be performed by a receiving component 725 as described with reference to FIG. 7.

At 810, the method may include writing first data to a first physical block address of the memory system in response to receiving the plurality of write commands, where the first data is associated with a first logical block address of the respective logical block addresses. In some examples, aspects of the operations of 810 may be performed by a writing component 730 as described with reference to FIG. 7.

At 815, the method may include determining whether a second logical block address associated with second data is sequential relative to a write pointer associated with the zone, where the write pointer indicates a position within the plurality of sequential logical block addresses of the zone for writing data. In some examples, aspects of the operations of 815 may be performed by a determining component 735 as described with reference to FIG. 7.

At 820, the method may include writing the second data to a second physical block address of the memory system that is sequential to the first physical block address in response to determining that the second logical block address is non-sequential relative to the write pointer and on a value of a bitmap corresponding to the second logical block address. In some examples, aspects of the operations of 820 may be performed by a writing component 730 as described with reference to FIG. 7.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving a plurality of write commands associated with respective logical block addresses that are in a sequential order, where the respective logical block addresses are associated with a zone of the memory system that includes a plurality of sequential logical block addresses; writing first data to a first physical block address of the memory system in response to receiving the plurality of write commands, where the first data is associated with a first logical block address of the respective logical block addresses; determining whether a second logical block address associated with second data is sequential relative to a write pointer associated with the zone, where the write pointer indicates a position within the plurality of sequential logical block addresses of the zone for writing data; and writing the second data to a second physical block address of the memory system that is sequential to the first physical block address in response to determining that the second logical block address is non-sequential relative to the write pointer and on a value of a bitmap corresponding to the second logical block address.
Aspect 2: The method, apparatus, or non-transitory computer-readable medium of aspect 1, further including operations, features, circuitry, logic, means, or instructions, or any combination thereof for incrementing a value of a counter in response to receiving the plurality of write commands and determining whether the value of the counter satisfies a threshold value corresponding to the plurality of sequential logical block addresses of the zone, where writing the first data to the first physical block address of the memory system is in response to determining that the value of the counter satisfies the threshold value.
Aspect 3: The method, apparatus, or non-transitory computer-readable medium of aspect 2, further including operations, features, circuitry, logic, means, or instructions, or any combination thereof for receiving a second plurality of write commands associated with respective logical block addresses in a sequential order; incrementing the value of a counter in response to receiving the second plurality of write commands; and refraining from writing third data associated with a third logical block address to a third physical block address of the memory system in response to determining that the value of the counter fails to satisfy the threshold value.
Aspect 4: The method, apparatus, or non-transitory computer-readable medium of aspect 3, further including operations, features, circuitry, logic, means, or instructions, or any combination thereof for closing the zone in response to determining that the value of the counter fails to satisfy the threshold value.
Aspect 5: The method, apparatus, or non-transitory computer-readable medium of any of aspects 1 through 4, further including operations, features, circuitry, logic, means, or instructions, or any combination thereof for determining the value of the bitmap corresponding to the second logical block address in response to determining that the second logical block address is non-sequential relative to the write pointer, where writing the second data to the second physical block address is in accordance with the value of the bitmap corresponding to the second logical block address including a first value.
Aspect 6: The method, apparatus, or non-transitory computer-readable medium of aspect 5, further including operations, features, circuitry, logic, means, or instructions, or any combination thereof for resetting the value of the bitmap corresponding to the second logical block address in response to writing the second data to the second physical block address.
Aspect 7: The method, apparatus, or non-transitory computer-readable medium of any of aspects 1 through 6, further including operations, features, circuitry, logic, means, or instructions, or any combination thereof for determining that a fourth logical block address associated with fourth data is non-sequential relative to the write pointer associated with the zone; determining that the value of the bitmap corresponding to the fourth logical block address includes a second value; and refraining from writing the fourth data to a fourth physical block address of the memory system in accordance with the value of the bitmap corresponding to the fourth logical block address including the second value.
Aspect 8: The method, apparatus, or non-transitory computer-readable medium of any of aspects 1 through 7, further including operations, features, circuitry, logic, means, or instructions, or any combination thereof for receiving a third plurality of write commands associated with respective logical block addresses in a sequential order, where the respective logical block addresses are associated with a second zone of the memory system that includes a plurality of sequential logical block addresses; opening the second zone of the memory system in response to receiving the third plurality of write commands; and allocating a second bitmap to the second zone in response to opening the second zone.
Aspect 9: The method, apparatus, or non-transitory computer-readable medium of any of aspects 1 through 8, further including operations, features, circuitry, logic, means, or instructions, or any combination thereof for writing, during a maintenance operation, the first data and fifth data to sequential physical block addresses of the memory system, where the first data and the fifth data are associated with sequential logical block addresses and were written to non-sequential physical block addresses prior to the maintenance operation.
Aspect 10: The method, apparatus, or non-transitory computer-readable medium of any of aspects 1 through 9, further including operations, features, circuitry, logic, means, or instructions, or any combination thereof for setting a value of the bitmap corresponding to the second logical block address to a first value in accordance with the second logical block address being non-sequential relative to the write pointer.
Aspect 11: The method, apparatus, or non-transitory computer-readable medium of any of aspects 1 through 10, further including operations, features, circuitry, logic, means, or instructions, or any combination thereof for incrementing the write pointer associated with the zone in response to writing the first data to the first physical block address of the memory system.
Aspect 12: The method, apparatus, or non-transitory computer-readable medium of any of aspects 1 through 11, where the first logical block address and the second logical block address are non-sequential logical block addresses.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit in response to the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a plurality of write commands associated with respective logical block addresses that are in a sequential order, wherein the respective logical block addresses are associated with a zone of the memory system that comprises a plurality of sequential logical block addresses;
write first data to a first physical block address of the memory system in response to receiving the plurality of write commands, wherein the first data is associated with a first logical block address of the respective logical block addresses;
determine whether a second logical block address associated with second data is sequential relative to a write pointer associated with the zone, wherein the write pointer indicates a position within the plurality of sequential logical block addresses of the zone for writing data; and
write the second data to a second physical block address of the memory system that is sequential to the first physical block address in response to determining that the second logical block address is non-sequential relative to the write pointer and on a value of a bitmap corresponding to the second logical block address.

2. The memory system of claim 1, wherein the processing circuitry is further configured to cause the memory system to:
increment a value of a counter in response to receiving the plurality of write commands; and
determine whether the value of the counter satisfies a threshold value corresponding to the plurality of sequential logical block addresses of the zone, wherein writing the first data to the first physical block address of the memory system is in response to determining that the value of the counter satisfies the threshold value.

3. The memory system of claim 2, wherein the processing circuitry is further configured to cause the memory system to:
receive a second plurality of write commands associated with respective logical block addresses in a sequential order;
increment the value of a counter in response to receiving the second plurality of write commands; and
refrain from writing third data associated with a third logical block address to a third physical block address of the memory system in response to determining that the value of the counter fails to satisfy the threshold value.

4. The memory system of claim 3, wherein the processing circuitry is further configured to cause the memory system to:
close the zone in response to determining that the value of the counter fails to satisfy the threshold value.

5. The memory system of claim 1, wherein the processing circuitry is further configured to cause the memory system to:
determine the value of the bitmap corresponding to the second logical block address in response to determining that the second logical block address is non-sequential relative to the write pointer, wherein writing the second data to the second physical block address is in accordance with the value of the bitmap corresponding to the second logical block address comprising a first value.

6. The memory system of claim 5, wherein the processing circuitry is further configured to cause the memory system to:
reset the value of the bitmap corresponding to the second logical block address in response to writing the second data to the second physical block address.

7. The memory system of claim 1, wherein the processing circuitry is further configured to cause the memory system to:
determine that a fourth logical block address associated with fourth data is non-sequential relative to the write pointer associated with the zone;
determine that the value of the bitmap corresponding to the fourth logical block address comprises a second value; and
refrain from writing the fourth data to a fourth physical block address of the memory system in accordance with the value of the bitmap corresponding to the fourth logical block address comprising the second value.

8. The memory system of claim 1, wherein the processing circuitry is further configured to cause the memory system to:
receive a third plurality of write commands associated with respective logical block addresses in a sequential order, wherein the respective logical block addresses are associated with a second zone of the memory system that comprises a plurality of sequential logical block addresses;
open the second zone of the memory system in response to receiving the third plurality of write commands; and
allocate a second bitmap to the second zone in response to opening the second zone.

9. The memory system of claim 1, wherein the processing circuitry is further configured to cause the memory system to:
write, during a maintenance operation, the first data and fifth data to sequential physical block addresses of the memory system, wherein the first data and the fifth data are associated with sequential logical block addresses and were written to non-sequential physical block addresses prior to the maintenance operation.

10. The memory system of claim 1, wherein the processing circuitry is further configured to cause the memory system to:
set a value of the bitmap corresponding to the second logical block address to a first value in accordance with the second logical block address being non-sequential relative to the write pointer.

11. The memory system of claim 1, wherein the processing circuitry is further configured to cause the memory system to:
increment the write pointer associated with the zone in response to writing the first data to the first physical block address of the memory system.

12. The memory system of claim 1, wherein the first logical block address and the second logical block address are non-sequential logical block addresses.

13. A non-transitory computer-readable medium storing code comprising instructions which, when executed by one or more processors of a memory system, cause the memory system to:
receive a plurality of write commands associated with respective logical block addresses that are in a sequential order, wherein the respective logical block addresses are associated with a zone of the memory system that comprises a plurality of sequential logical block addresses;
write first data to a first physical block address of the memory system in response to receiving the plurality of write commands, wherein the first data is associated with a first logical block address of the respective logical block addresses;
determine whether a second logical block address associated with second data is sequential relative to a write pointer associated with the zone, wherein the write pointer indicates a position within the plurality of sequential logical block addresses of the zone for writing data; and
write the second data to a second physical block address of the memory system that is sequential to the first physical block address in response to determining that the second logical block address is non-sequential relative to the write pointer and on a value of a bitmap corresponding to the second logical block address.

14. The non-transitory computer-readable medium of claim 13, wherein the instructions, when executed by the one or more processors of the memory system, further cause the memory system to:
increment a value of a counter in response to receiving the plurality of write commands; and
determine whether the value of the counter satisfies a threshold value corresponding to the plurality of sequential logical block addresses of the zone, wherein writing the first data to the first physical block address of the memory system is in response to determining that the value of the counter satisfies the threshold value.

15. The non-transitory computer-readable medium of claim 14, wherein the instructions, when executed by the one or more processors of the memory system, further cause the memory system to:
receive a second plurality of write commands associated with respective logical block addresses in a sequential order;
increment the value of a counter in response to receiving the second plurality of write commands; and
refrain from writing third data associated with a third logical block address to a third physical block address of the memory system in response to determining that the value of the counter fails to satisfy the threshold value.

16. The non-transitory computer-readable medium of claim 15, wherein the instructions, when executed by the one or more processors of the memory system, further cause the memory system to:
close the zone in response to determining that the value of the counter fails to satisfy the threshold value.

17. The non-transitory computer-readable medium of claim 13, wherein the instructions, when executed by the one or more processors of the memory system, further cause the memory system to:
determine the value of the bitmap corresponding to the second logical block address in response to determining that the second logical block address is non-sequential relative to the write pointer, wherein writing the second data to the second physical block address is in accordance with the value of the bitmap corresponding to the second logical block address comprising a first value.

18. The non-transitory computer-readable medium of claim 17, wherein the instructions, when executed by the one or more processors of the memory system, further cause the memory system to:
reset the value of the bitmap corresponding to the second logical block address in response to writing the second data to the second physical block address.

19. The non-transitory computer-readable medium of claim 13, wherein the instructions, when executed by the one or more processors of the memory system, further cause the memory system to:
determine that a fourth logical block address associated with fourth data is non-sequential relative to the write pointer associated with the zone;
determine that the value of the bitmap corresponding to the fourth logical block address comprises a second value; and
refrain from writing the fourth data to a fourth physical block address of the memory system in accordance with the value of the bitmap corresponding to the fourth logical block address comprising the second value.

20. The non-transitory computer-readable medium of claim 13, wherein the instructions, when executed by the one or more processors of the memory system, further cause the memory system to:
receive a third plurality of write commands associated with respective logical block addresses in a sequential order, wherein the respective logical block addresses are associated with a second zone of the memory system that comprises a plurality of sequential logical block addresses;
open the second zone of the memory system in response to receiving the third plurality of write commands; and
allocate a second bitmap to the second zone in response to opening the second zone.

21. The non-transitory computer-readable medium of claim 13, wherein the instructions, when executed by the one or more processors of the memory system, further cause the memory system to:
write, during a maintenance operation, the first data and fifth data to sequential physical block addresses of the memory system, wherein the first data and the fifth data are associated with sequential logical block addresses and were written to non-sequential physical block addresses prior to the maintenance operation.

22. The non-transitory computer-readable medium of claim 13, wherein the instructions, when executed by the one or more processors of the memory system, further cause the memory system to:
set a value of the bitmap corresponding to the second logical block address to a first value in accordance with the second logical block address being non-sequential relative to the write pointer.

23. The non-transitory computer-readable medium of claim 13, wherein the instructions, when executed by the one or more processors of the memory system, further cause the memory system to:
increment the write pointer associated with the zone in response to writing the first data to the first physical block address of the memory system.

24. The non-transitory computer-readable medium of claim 13, wherein the first logical block address and the second logical block address are non-sequential logical block addresses.

25. A method by a memory system, comprising:
receiving a plurality of write commands associated with respective logical block addresses that are in a sequential order, wherein the respective logical block addresses are associated with a zone of the memory system that comprises a plurality of sequential logical block addresses;
writing first data to a first physical block address of the memory system in response to receiving the plurality of write commands, wherein the first data is associated with a first logical block address of the respective logical block addresses;
determining whether a second logical block address associated with second data is sequential relative to a write pointer associated with the zone, wherein the write pointer indicates a position within the plurality of sequential logical block addresses of the zone for writing data; and
writing the second data to a second physical block address of the memory system that is sequential to the first physical block address in response to determining that the second logical block address is non-sequential relative to the write pointer and on a value of a bitmap corresponding to the second logical block address.
